(19) United States
(12) Patent Application Publication
(10) Pub. No.: US 2025/0382183 A1
(43) Pub. Date: Dec. 18, 2025

(54) PROCESS FOR PRODUCING PHOSGENE

(71) Applicant: BASF SE, Ludwigshafen am Rhein (DE)

(72) Inventors: Gerhard OLBERT, Ludwigshafen am Rhein (DE); Kai THIELE, Antwerpen (BE); Peter VAN DEN ABEEL, Antwerpen (BE); Jens FERBITZ, Ludwigshafen am Rhein (DE); Torsten MATTKE, Ludwigshafen am Rhein (DE)

(21) Appl. No.: 18/878,926

(22) PCT Filed: Jun. 29, 2023
(86) PCT No.: PCT/EP2023/067815

§ 371 Date: Dec. 26, 2024

(30) Foreign Application Priority Data
Jun. 30, 2022 (EP) 22182135.8

(51) Int. Cl. C01B 32/80

(52) U.S. Cl. CPC C01B 32/80

(57) ABSTRACT

The invention relates to a process for producing phosgene by reacting carbon monoxide and chlorine in the presence of a heterogeneous catalyst, comprising: (a) feeding the chlorine and the carbon monoxide into at least one reaction tube which contains the catalyst; (b) reacting the chlorine and the carbon monoxide, thereby forming a phosgene containing reaction gas; (c) cooling the at least one reaction tube by indirect heat transfer to a heat transfer medium which flows through a space surrounding the at least one reaction tube; (d) withdrawing the phosgene containing reaction gas from the at least one reaction tube, wherein the heat transfer medium supplied to the space surrounding the at least one reaction tube has an entrance temperature which is increased from a starting temperature to a maximum temperature.

The invention relates to a process for producing phosgene by reacting carbon monoxide and chlorine in the presence of a heterogeneous catalyst, comprising:
(a) feeding the chlorine and the carbon monoxide into at least one reaction tube which contains the catalyst;
(b) reacting the chlorine and the carbon monoxide, thereby forming a phosgene containing reaction gas;
(c) cooling the at least one reaction tube by indirect heat transfer to a heat transfer medium which flows through a space surrounding the at least one reaction tube;
(d) withdrawing the phosgene containing reaction gas from the at least one reaction tube.

Phosgene is an important chemical in the production of intermediates and end products in almost all branches of chemistry. The largest application in terms of quantity is the preparation of diisocyanates for polyurethane chemistry, in particular toluene diisocyanate and diphenylmethane-4,4′-diisocyanate.

In industrial scale, phosgene is usually produced in a catalytic gas phase reaction of carbon monoxide and chlorine in the presence of a solid catalyst, preferably activated carbon. The reaction is strongly exothermic and is usually carried out in a shell-and-tube reactor according to the process described in Ullmann's Encyclopedia of Industrial Chemistry, Wiley-VCH Verlag GmbH & Co. KGaA, Weinheim, pages 625 to 626, DOI: 10.1002/14356007.a19_411.

The catalyst used in the reaction usually has a particle size in the range from 3 mm to 5 mm and the tubes used in the shell-and-tube reactor have an internal diameter of 30 to 70 mm. The reaction starts at a temperature of 40 to 50° C., increases in the tubes to about 580° C. and then drops again. Carbon monoxide is used in small excess to ensure that all chlorine is converted and to obtain chlorine-free phosgene. The reaction can be carried out without pressure or under pressure in order to be able to condense at least part of the phosgene already with cooling water. As the reaction is strongly exothermic, the temperature rises very quickly and in a short distance from the entrance into the reaction tube, a hot spot forms at which the maximum temperature occurs. The high reaction temperatures also results in heating the material of the tubes. To avoid corrosion and a damage of the reaction tubes, the tubes are cooled with a heat transfer medium. The temperature of the heat transfer medium is selected such that the temperature of the tube walls does not extend a critical temperature at the hot spot. The critical temperature usually is determined from knowledge regarding corrosion of the material of the reactor tubes and, thus, also depends from the material used for the reactor tubes.

A corresponding process is described, for example, in WO-A 03/072237. In order to be able to dissipate the heat of reaction more effectively, a reactor is used which has a bundle of contact tubes arranged parallel to one another in the longitudinal direction of the reactor and fastened at their ends in tube sheets, with a hood at each end of the reactor, and with baffles arranged perpendicularly to the longitudinal direction of the reactor in the interspace between the contact tubes, which baffles leave passage openings alternately opposite one another on the inner wall of the reactor, the contact tubes being filled with the solid catalyst, the gaseous reaction mixture being passed from one reactor end via a hood through the contact tubes and being drawn off from the opposite reactor end via the second hood, and a liquid heat-exchange medium being passed through the interspace between the contact tubes, and the reactor being unpierced in the region of the passage openings.

Further processes for producing phosgene by reaction of carbon monoxide and chlorine in the presence of activated carbon as catalyst in tubes of a tube-and-shell reactor are described for example in EP-A 0 134 506, EP-A 1 640 341 or WO-A 2014/009346.

It is a disadvantage of all known processes that the catalyst deactivates over time, which leads to a shift of the hot spot in the direction of flow and finally to an incomplete conversion of the chlorine. If the chlorine concentration at the reactor outlet exceeds a critical value, the production plant is shut down, the catalyst is replaced and the production plant is started up again. This process each time results in a loss of yield.

Therefore, it is an object of the present invention to provide a process for producing phosgene by reaction of chlorine and carbon monoxide in which the time between two necessary shutdowns for replacing the catalyst is increased, by which the number of shut downs is reduced and, thus, also the yield can be increased.

This object is achieved by a process for producing phosgene by reacting carbon monoxide and chlorine in the presence of a heterogeneous catalyst, comprising:
(a) feeding the chlorine and the carbon monoxide into at least one reaction tube which contains the catalyst;
(b) reacting the chlorine and the carbon monoxide, thereby forming a phosgene containing reaction gas;
(c) cooling the at least one reaction tube by indirect heat transfer to a heat transfer medium which flows through a space surrounding the at least one reaction tube;
(d) withdrawing the phosgene containing reaction gas from the at least one reaction tube, wherein the heat transfer medium supplied to the space surrounding the at least one reaction tube has an entrance temperature which is increased from a starting temperature to a maximum temperature.

For producing phosgene, chlorine and carbon monoxide are fed into the at least one reaction tube which contains the solid catalyst, preferably activated carbon. The process is carried out as described for example in Ullmann's Encyclopedia of Industrial Chemistry, Wiley-VCH Verlag GmbH & Co. KGaA, Weinheim, pages 625 to 626, DOI: 10.1002/14356007.a19_411.

Usually, not only one reaction tube is used for producing phosgene but a plurality of reaction tubes. The reaction tubes preferably are arranged in parallel in a shell-and-tube reactor. Such a reactor is described for example in WO-A 03/072237. The catalyst used in the reaction usually has a particle size in the range from 3 mm to 5 mm and the tubes used in the shell-and-tube reactor have an internal diameter of 30 to 70 mm. The reaction starts at a temperature of 40 to 50° C., increases in the tubes to about 580° C. and then drops again. In the context with the present invention, the region in the reaction tubes at which the maximum temperature occurs is called “hot spot”. Carbon monoxide is used in small excess to ensure that all chlorine is converted and to obtain chlorine-free phosgene. The reaction can be carried out without pressure or under pressure in order to be able to condense at least part of the phosgene already with cooling water. Usually the shell-and-tube reactor is arranged such that the reaction tubes are oriented vertically. The carbon monoxide and the chlorine are fed into the reaction tubes at the top of the shell-and-tube reactor and the reaction product obtained by reaction of the carbon monoxide and chlorine in the reaction tubes is withdrawn at the bottom of the shell-and-tube reactor.

As the reaction is strongly exothermic, the temperature rises very quickly and forms the hot spot in a short distance from the entrance into the reaction tube, when using a fresh catalyst. The high reaction temperature also results in heating the material of the tubes. To minimize corrosion and, thus, a damage of the reaction tubes, the reaction tubes are cooled with the heat transfer medium. The entrance temperature of the heat transfer medium is selected such that the temperature of the walls of the reaction tubes does not extend a critical temperature at the hot spot. The critical temperature usually is determined from knowledge regarding corrosion of the material of the reactor tubes and, thus, also depends from the material used for the reactor tubes. The critical temperature can be determined as known by the skilled person and as carried out in present processes for producing phosgene.

During operation of the reaction tubes, the hot spot moves in direction of flow of the media flowing through the reaction tube and also becomes a larger extension, due to deactivation of the catalyst. This change of shape of the hot spot results in a decrease of the maximum temperature in the reaction tube, which allows for the higher entrance temperature of the heat transfer medium without increasing the risk for corrosion of the material of the reactor tubes, because despite the higher entrance temperature, the temperature of the walls of the reaction tubes does not exceed a critical temperature at which corrosion of the material of the walls is promoted.

Surprisingly it has shown that by this increase of the entrance temperature of the heat transfer medium the runtime of the reactor can be extended and that the increasing entrance temperature of the heat transfer medium also results in a reduction of the deactivation rate of the catalyst.

When the reaction tubes are filled with a fresh catalyst, the heat transfer medium is supplied to the reactor with a starting temperature. The starting temperature thereby is determined such that the maximum temperature of the walls of the reaction tubes at the hot spot remains below the critical temperature. Preferably, the starting temperature of the heat transfer medium supplied to the space surrounding the reaction tube is in a range from condensation temperature of the phosgene at reaction pressure +5 K to condensation temperature of the phosgene at reaction pressure +100 K, more preferred in a range from the condensation temperature of the phosgene at reaction pressure +5 K to condensation temperature of the phosgene at reaction pressure +80 K and particularly in a range from condensation temperature of the phosgene at reaction pressure +5 K to condensation temperature of the phosgene at reaction pressure +50 K.

The heat transfer medium used for cooling the reaction tubes may flow around the reaction tube in co-current, in counter-current, in cross-co-current or cross-counter-current flow. Particularly preferably, the heat transfer medium flows around the reaction tube in cross-co-current or cross-counter-current flow. If the reaction tube is arranged in a shell-and-tube reactor, it is preferred if baffles are installed in the reactor. The baffles preferably are arranged perpendicular to the direction of the reaction tubes as described for example in WO-A 03/072237.

As an alternative to the reactor described in WO-A 03/072237 with the opposite passage openings at the inner wall of the reactor, it is also possible, for example, to use baffle plates which have a passage opening alternately all around the inner wall of the reactor and in the center of the baffle. In this case, during normal operation the heat transfer medium first flows from the outside to the center of the baffle plate, through the passage opening in the center of the baffle plate onto the baffle plate below, on the latter in radial direction to the reactor inner wall and then through the passage opening running around the reactor inner wall onto the baffle plate below, which again has a passage opening in the center. Since, due to the design of the shell-and-tube reactor, the heat transfer medium is usually added and removed via side inlets in the reactor shell, in this case the uppermost and the lowermost baffle plates are provided with a passage opening in the middle. The addition point and removal point for the heat transfer medium are located above the uppermost baffle and below the lowermost baffle. As an alternative to the flow from top to bottom as described above, it is also possible to feed the heat transfer medium at the bottom and remove it at the top so that it flows from the bottom to the top. Using the baffles results in a cross-co-current flow if the heat transfer medium flows in the same direction as the media inside the reaction tubes, and in a cross-counter-current flow if the heat transfer medium and the mixture of chlorine and carbon monoxide are fed into the reactor at opposite ends of the reactor.

The heat transfer medium used for cooling the reaction tubes in the reactor can be any heat transfer medium which is stable at the temperatures in the reactor. For cooling the reactor tubes, a liquid heat transfer medium can be used or a heat transfer medium which at least partly evaporates due to absorption of the reaction heat. Suitable heat transfer media particularly are water, an aqueous sodium hydroxide solution or at least one optionally substituted hydrocarbon, preferably at least one optionally substituted aromatic hydrocarbons and particularly at least one chlorinated hydrocarbon, for example chlorobenzene.

Usually the catalyst in the reaction tubes begins to deactivate from starting the reaction using fresh catalyst. This deactivation results in the movement of the hot spot. Increasing the entrance temperature of the heat transfer medium preferably is started after the hot spot shifted to a specified position. This specified position and, thus, the starting point for increasing the entrance temperature of the heat transfer medium can be determined as described below.

The entrance temperature of the heat transfer medium may be increased continuously or stepwise in one or more steps until the maximum temperature is reached. Particularly preferably, the entrance temperature of the heat transfer medium is increased stepwise in at least one step.

If the entrance temperature of the heat transfer medium is increased stepwise, all steps may have the same size or the temperature increase of the steps may differ. If the temperature increase differs, it is for example possible to start with small steps and to increase the temperature steps from step to step. Besides constant or varying temperature steps for each step, the time the temperature is kept constant in each step also may be same or different for each step. If the time the temperature is kept constant differs from step to step, this time preferably is determined by the velocity with which the hot spot is moving in the reaction tube.

Independently of increasing the temperature in constant steps or in varying steps and independently if the time the temperature is kept constant is the same for each step or differs from step to step, it is further preferred to determine the position and the size of the hot spot for determining the starting point of a following step.

If the entrance temperature of the heat transfer medium is increased continuously, the starting point and the gradient for the temperature increase of the entrance temperature also preferably are determined by determining the movement of the hot spot.

The maximum temperature to which the entrance temperature is increased preferably is 5 to 80 K above the starting temperature. More preferred, the maximum temperature to which the entrance temperature is increased is in a range from 20 to 65 K above the starting temperature and particularly 30 to 50 K above the starting temperature. If the entrance temperature of the heat transfer medium is increased stepwise, the temperature preferably is increased in each step by 1 to 50 K, more preferred by 2 to 25 K and particularly 5 to 15 K. In this case, the temperature of each step is kept constant until the conditions for increasing the entrance temperature of the heat transfer medium are met again.

The starting point and/or the gradient of the temperature increase of the entrance temperature of the heat transfer medium preferably is determined by at least one of:
(i) measuring a temperature profile in at least one of the reaction tubes;
(ii) measuring a temperature profile in the space surrounding the at least one reaction tube;
(iii) measuring the temperature of the reaction gas withdrawn from the at least one reaction tube;
(iv) measuring the content of chlorine in the reaction gas;
(v) determining an increase in temperature of the reaction gas in an adiabatic post-reactor;
(vi) determining an increase in temperature of a cooling medium in a cooled post-reactor.

If for determining the starting point and/or the gradient of the temperature increase is determined by measuring the temperature profile in at least one of the reaction tubes, any device for measuring the temperature known to a skilled person and which is not damaged by the components which come into contact with components of the device for measuring the temperature can be used. Suitable devices for measuring the temperature are, for example, temperature measuring devices which are placed in a thermowell. The temperature measuring devices may be distributed over the length of the reaction tube. The distribution of the temperature measuring devices may be uniformly or unequally over the length of the reaction tube. By measuring the temperature using temperature measuring devices being distributed over the length of the reaction tube, the present position of the hot spot can be determined as the temperature increases from the entry of the chlorine and the carbon monoxide into the reaction tube to the hot spot and then decreases from the hot spot to the exit of the reaction tube where the reaction product is withdrawn.

As usually a largely complete conversion of the chlorine and the carbon monoxide can be ensured as long as the hot spot is in the upper part of the reaction tube, the starting point for increasing the entrance temperature of the heat transfer medium may be selected such that the hot spot is in the lower part of the reaction tube when the increase of the entrance temperature starts. Independently of the direction of the reactor and the direction of flow of the reaction gases through the reaction tubes, the “lower part” in this context is that part of the reaction part which ends in the withdrawal point for the reaction medium and the “upper part” is that part which follows the inlet of the tube. Thus, the reaction gases, particularly chlorine and carbon monoxide enter the tube at the upper part flow from the upper part to the lower part and then the resulting reaction mixture leaves the reaction tube. The lower part and the upper part preferably each form one half of the reaction tube. For determining whether the hot spot is in the lower part of the reaction tube, it is sufficient to provide temperature measuring devices, particularly thermocouples, in the lower part of the reaction tube. In this case, the hot spot is gathered when it reaches the highest position at which the temperature is measured.

As the reaction is not completed at the hot spot but continues after passing the position of the hot spot at decreasing temperature, it is preferred to determine the starting point for increasing the entrance temperature of the heat transfer medium by reaching a specified temperature at a specified position in the reactor. The position at which the specified temperature is reached, preferably is selected such, that when the specified temperature is reached at the specified position, the chlorine is still largely completely converted. The specified temperature may be any temperature which is below the temperature of the hot spot. Preferably, the specified temperature is a temperature in the range between 50 and 200° C. above the entrance temperature of the heat transfer medium. The specified position at which the specified temperature is reached may be determined for example by a simulation calculation or by experiment. Decrease of the temperature after the reaction mixture passed the hot spot is due to a slower reaction velocity and cooling of the reaction tubes. For this reason, the temperature of the reaction gas withdrawn from the reactor has almost the same temperature as the heat transfer medium at the position at which the reaction gas is withdrawn, as long as the chlorine is converted completely.

Alternatively or additionally to measuring the temperature in at least one of the reaction tubes the temperature in the space surrounding the at least one reaction tube may be measured. If the heat transfer medium flows in co-current or counter current, temperature measuring devices may be arranged in the space through which the heat transfer medium flows at different heights in a manner comparable to the above described arrangement for temperature measuring devices in at least one reaction tube.

If a tube-and-shell reactor is used as described for example in WO-A 03/072237 where baffles are arranged in the space surrounding the reaction tubes so that the heat transfer medium flows in a cross-co-current or in a cross-counter-current manner, it is preferred when the temperature measuring devices are located in the deflection sections and particularly only in the deflection sections. Using such an arrangement, the hot spot is located at a position between those temperature measuring devices at which the highest temperature difference is measured.

Independently of measuring the temperature in the reaction tubes by using temperature measuring devices in a thermowell or by measuring the temperature of the heat transfer medium, these two options allow for a precise determination of the location and the size of the hot spot.

A further possibility for the determination of the location and the temperature of the hot spot is by a simulation calculation of the temperature profile based on the temperature at a specific position in the reaction tube. Such a simulation calculation may be carried out for example as described in C. J. Mitchell et al., “Selection of carbon catalysts for the industrial manufacture of phosgene”, Catal. Sci. Technol., 2012, 2, 2109-2115, DOI: 10 1039/C2CY20224G.

As a further alternative or additionally, the temperature of the reaction gas withdrawn from the at least one reaction tube may be measured for determining the starting point of the increase of the entrance temperature of the heat transfer medium. Even though the reaction is very fast, the reaction of chlorine and carbon monoxide forming phosgene is only partly completed at the hot spot. After passing the hot spot, the reaction continues at a lower reaction velocity. Therefore, and due to cooling of the reaction tubes, the temperature of the reaction components decrease after passing the hot spot. If the temperature of the reaction product leaving the at least one reaction tube is measured, an increase of the temperature shows that the hot spot has moved to a position in the reaction tube which is such that the remaining length of the tube is not sufficient for a largely complete conversion of chlorine and carbon monoxide forming phosgene. Therefore, measuring the temperature of the reaction gas withdrawn from the at least one reaction tube can be used for determining the location of the hot spot and thus the starting point for increasing the entrance temperature of the heat transfer medium. Preferably, the temperature difference between the heat transfer medium and the reaction gas at the withdrawal position of the reaction gas is determined. If the heat transfer medium flows in countercurrent or cross-counter-current, the temperature difference is determined between the temperature of the reaction gas withdrawn from the reactor and the entrance temperature of the heat transfer medium, if the heat transfer medium flows in co-current or cross-co-current, the temperature difference is determined between the temperature of the reaction gas withdrawn from the reactor and the exit temperature of the heat transfer medium. As soon as this temperature difference increases for a predetermined value, the entrance temperature of the heat transfer medium is increased. Preferably, the entrance temperature of the heat transfer medium is increased when the temperature difference between the heat transfer medium and the reaction gas is in a range between 1 and 10 K.

A further option to determine the starting point for increasing the entrance temperature of the heat transfer medium is the measurement of the content of chlorine in the reaction gas. As long as the hot spot is at a position close to the entrance of the chlorine and the carbon monoxide, the total chlorine is converted to phosgene and no chlorine is detected in the reaction gas which is withdrawn from the at least one reaction tube. Due to the deactivation of the catalyst and thus the movement of the hot spot, the total amount of chlorine in the reaction mixture is no longer converted when the hot spot moves to the end of the reaction tube. Therefore, chlorine can be detected in the reaction gas. Usually, the catalyst needs to be replaced before the content of chlorine in the reaction product reaches a critical value. Therefore, to increase the lifetime of the catalyst, the starting point for increasing the entrance temperature of the heat transfer medium is in the range between the first detection of chlorine in the reaction gas and reaching the critical value. The starting point for increasing the temperature may be that point at which firstly chlorine is detected in the reaction gas. Preferably the starting point for increasing the temperature of the heat transfer medium is that point at which the concentration of chlorine in the reaction gas which is withdrawn from the reaction tube is in a range between 1 and 1000 ppm, more preferred in a range between 2 and 500 ppm and particularly in a range between 10 and 100 ppm.

For detecting chlorine in the reaction gas, particularly UV-VIS spectroscopy can be used.

To ensure, that chlorine free phosgene is produced even in case the hot spot moved upwards in the reaction tubes, the reactor may be followed by a post reactor. In the post reactor, chlorine which still may be contained in the reaction gas is converted by reaction with carbon monoxide forming phosgene.

If an adiabatic post reactor is used and the temperature of the reaction gas in the post reactor increases, this is an indication for an incomplete conversion in the main reactor, because this temperature increase usually results from the reaction of chlorine with carbon monoxide. The incomplete conversion for example results from the deactivation of the catalyst in the main reactor and the movement of the hot spot.

If a cooled post reactor is used, reaction heat resulting from the conversion of chlorine and carbon monoxide forming phosgene in the post reactor is transferred to the cooling medium, thereby heating the cooling medium. Therefore, by determining an increase in temperature of the cooling medium, a reaction which takes place in the post reactor and which indicates an incomplete conversion of chlorine in the main reactor, is detected.

In each case as soon as chlorine is detected in the reaction gas leaving the main reactor, either by measuring the chlorine content in the reaction gas or by determining an increase of the temperature of the reaction gas if an adiabatic post reactor is used or by an increase of the temperature of the cooling medium if a cooled post reactor is used, the hot spot moved to a position close to the end of the reaction tubes and by increasing the entrance temperature of the heat transfer medium the reaction in the main reactor can be improved and, thus, the lifetime of the catalyst can be extended.

However, particularly preferably, a measure for determining the position of the hot spot is used which allows a detection of the hot spot right in time before the conversion of chlorine in the reaction tubes is incomplete.

Independently of whether a temperature profile is measured in at least one reaction tube or in the space surrounding the at least one reaction tube or the temperature of the reaction gas withdrawn from the at least one reaction tube is measured or an increase in temperature of the reaction gas in an adiabatic post-reactor or an increase in temperature of a cooling medium in a cooled post-reactor is determined, suitable temperature measuring devices for measuring the respective temperatures are for example thermocouples or temperature sensors.

### EXAMPLE

A pilot-scale reaction tube of 39.3 mm inner diameter and 2 m length was filled with an activated carbon catalyst (Donau Carbon, 4 mm extrudates). The length of only 2 m was selected to achieve a quick chlorine breakthrough. A mass flow of 9.4 kg/h chlorine and 4.1 kg/h carbon monoxide with a temperature of about 50° C. was fed into the reaction tube. The tube was cooled with liquid chlorobenzene flowing around the tube. When starting the reaction, the entrance temperature of the liquid chlorobenzene was set to 85° C. and after 72 days, the entrance temperature was increased to 128° C.

The outlet concentration of chlorine was measured by UV-VIS. A multi-thermocouple delivered temperatures inside the reaction at different positions. Deactivation of the catalyst leads to a shift of the temperature profile and increasing chlorine concentration at the outlet. The shift of temperature profile is characterized by the position at which the temperature of 250° C. is crossed downstream the hot spot. This position is derived from interpolation between adjacent temperature measurements.

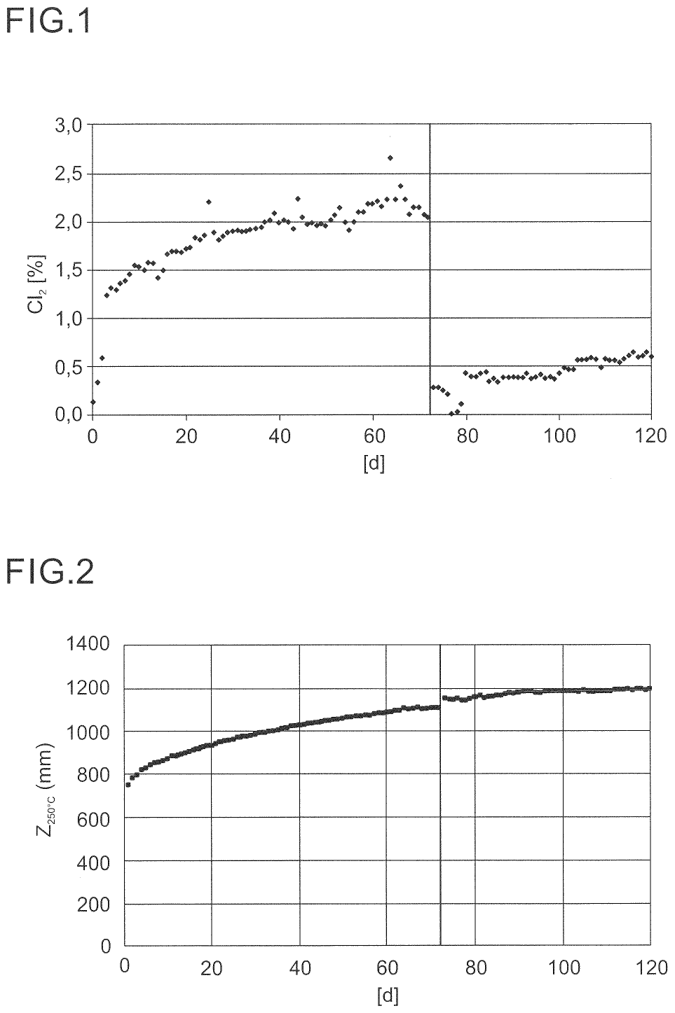

The results are shown in FIGS. 1 and 2, in which:

FIG. 1 shows the chlorine concentration at the outlet as a function of the runtime;

FIG. 2 shows the position at which the temperature of 250° C. is crossed downstream the hot spot as a function of the runtime.

As can be seen in FIG. 1, the concentration of chlorine at the outlet of the reactor increased shortly after starting the reaction to a value of about 2% and showed a further slight increase. The relatively high concentration of chlorine resulted from the short reaction tube having a length of only 2 m, whereas in a commercially used reactor, the length of the reaction tube usually is at least 3 m and for this reason the concentration of the chlorine in the reaction gas obtained in the commercial reactor is much lower than in the reaction tube used in the examples.

After increasing the entrance temperature of the chlorobenzene used as heat transfer medium from 85° C. to 128° C., the content of chlorine in the reaction gas at the outlet was reduced to about 0.5 vol.-%. This shows that after increasing the entrance temperature of the heat transfer medium more chlorine was converted to phosgene.

Further, FIG. 2 shows that the position at which the temperature of 250° C. is crossed downstream the hot spot migrated about 3.1 mm/d before the entrance temperature of the heat transfer medium was increased and, after a slight shift when increasing the entrance temperature of the heat transfer medium, only 1 mm/d after increasing the entrance temperature of the heat transfer medium. This shows that an increased entrance temperature of the heat transfer medium results in a slower shift of the hot spot and, thus, that the lifetime of the catalyst can be increased.

1.-9. (canceled)

10. A process for producing phosgene by reacting carbon monoxide and chlorine in the presence of a heterogeneous catalyst, comprising:
(a) feeding the chlorine and the carbon monoxide into at least one reaction tube which contains the catalyst;
(b) reacting the chlorine and the carbon monoxide, thereby forming a phosgene containing reaction gas;
(c) cooling the at least one reaction tube by indirect heat transfer to a heat transfer medium which flows through a space surrounding the at least one reaction tube;
(d) withdrawing the phosgene containing reaction gas from the at least one reaction tube, wherein the heat transfer medium supplied to the space surrounding the at least one reaction tube has an entrance temperature which is increased from a starting temperature to a maximum temperature.

11. The process according to claim 10, wherein a starting point or a gradient of the temperature increase of the entrance temperature of the heat transfer medium is determined by at least one of:
(i) measuring a temperature profile in at least one of the reaction tubes;
(ii) measuring a temperature profile in the space surrounding the at least one reaction tube;
(iii) measuring the temperature of the reaction gas withdrawn from the at least one reaction tube;
(iv) measuring the content of chlorine in the reaction gas;
(v) determining an increase in temperature of the reaction gas in an adiabatic post-reactor;
(vi) determining an increase in temperature of a cooling medium in a cooled post-reactor.

12. The process according to claim 10, wherein the at least one reaction tube is a tube in a shell-and-tube reactor.

13. The process according to claim 10, wherein the heat transfer medium flows around the reaction tube in co-current, in counter-current, in cross-co-current or cross-counter-current flow.

14. The process according to claim 10, wherein the starting temperature of the heat transfer medium supplied to the space surrounding the reaction tube is in a range from condensation temperature of the phosgene at reaction pressure +5 K to condensation temperature of the phosgene at reaction pressure +100 K.

15. The process according to claim 10, wherein the maximum temperature of the heat transfer medium is 5 to 80 K above the starting temperature.

16. The process according to claim 10, wherein the temperature of the heat transfer medium is increased stepwise until the maximum temperature is reached.

17. The process according to claim 10, wherein the temperature of the heat transfer medium is increased continuously.

18. The process according to claim 10, wherein the heat transfer medium is water, an aqueous sodium hydroxide solution or at least one optionally substituted hydrocarbon.
